(19) United States
(12) Patent Application Publication
(10) Pub. No.: US 2024/0026250 A1
(43) Pub. Date: Jan. 25, 2024

(54) LIQUID DETERGENT COMPOSITION FOR HOUSEHOLD OR INDUSTRIAL USE COMPRISING A POLYMER IN THE FORM OF A PULVERULENT SOLID AS THICKENING AGENT

(71) Applicant: SOCIETE D'EXPLOITATION DE PRODUITS POUR LES INDUSTRIES CHIMIQUES SEPPIC, PARIS CEDEX 07 (FR)

(72) Inventors: Miruna BODOC, CASTRES (FR); Stéphane MONTEILLET, CASTRES (FR)

(21) Appl. No.: 18/256,562

(22) PCT Filed: Nov. 30, 2021
(86) PCT No.: PCT/EP2021/083626

§ 371 Date: Jun. 8, 2023

(30) Foreign Application Priority Data
Dec. 14, 2020 (FR) 2013178

(51) Int. Cl. C11D 3/37; C11D 17/00; C11D 11/00

(52) U.S. Cl. CPC C11D 3/3723; C11D 17/0008; C11D 11/0023

(57) ABSTRACT

Disclosed is a liquid detergent composition (F) for domestic or industrial use, comprising at least one detergent surfactant and, as thickening agent, a polymer (P) in the form of a pulverulent solid consisting of monomeric units derived from partially or totally salified glutamic acid (GA), and monomer units of at least one crosslinking agent (AR) having at least two glycidic functions.

The present invention relates to a liquid detergent composition (F) for household or industrial use, comprising, as thickening agent, a polymer (P) in the form of a pulverulent solid, and to the process for preparing said liquid detergent composition (F).

Polymers are widely used today in detergent compositions and represent the second most widely used family of products in compositions of this type. Detergent compositions contain polar phases, for example phases consisting of water, and in most cases require the use of rheology modifiers, for example polymers, to increase the viscosity of these polar phases, and also to impart well-defined rheological behavior.

Polymers that modify the rheology of polar phases include natural polymers, for example polysaccharides based on saccharides or polysaccharides based on saccharide derivatives, or else synthetic polymers of linear or branched, crosslinked or noncrosslinked, anionic or cationic or amphiphilic polyelectrolyte type. Predominantly present on the market, synthetic polymers have the property of being deployed, in the polar phase, under the effect of electrostatic repulsions due to the presence of charges (negative and/or positive) on the linear or branched, crosslinked or noncrosslinked polymer backbone. These rheology modifiers bring both an increase in the viscosity of the polar phase, and also a certain consistency and/or a stabilizing effect imparted to the liquid detergent composition.

In order to meet the needs of formulators and to improve performance, various recent scientific studies have reported the development of new, innovative and varied polymeric systems. Thus, the polymers used in the detergent industries can play a functional role as film-forming agents, rheology modifiers, enabling stabilization of the fatty phases in emulsions of the water-in-oil type and of the oil-in-water type, stabilization of solid particles (pigments and fillers) or as agents having an impact on the appearance of the formula (transparency, translucency, opacity).

Polymers that modify the rheology of polar phases, and more particularly of aqueous phases, are mainly polyelectrolytes resulting from the free-radical polymerization of (meth)acrylic monomers, i.e. acrylic acid or methacrylic acid, ester derivatives of acrylic acid or methacrylic acid, or else derivatives of acrylamide or methacrylamide.

Developing new biobased and biodegradable rheology modifiers that are as efficient as the synthetic polymers currently used still constitutes a major challenge today. Indeed, until now the solutions mainly used for thickening aqueous phases involve ingredients originating from petrochemical materials and in particular acrylic acid and derivatives thereof, or methacrylic acid and derivatives thereof.

Given the growing consumer concern for a sustainable and responsible economy and development, the replacement of raw materials of petrochemical origin with raw materials of renewable origin in polymer production is a priority research area.

To date, the literature has described the use of various natural polymers or polymers from renewable raw materials, with monomer units which come from the family of sugars (glucose, arabinose, xylose, galactose, mannose, ribose, glucuronic acid, etc.) or from the family of amino acids (glutamic acid, aspartic acid, lysine, etc.). These polymers are mostly linear or branched depending on the plant from which they come or according to their manufacturing process.

As an example of a polymer of natural origin, mention may be made of polyglutamic acid (PGA), which is currently the subject of numerous research studies. It is a predominantly linear polymer and consists of glutamic acid (GA) monomer units. Glutamic acid is an amino acid characterized by an amine function in the α position and by two carboxylic acid functions (or carboxylates depending on the pH) in the α and γ positions (cf. chemical formula 1).

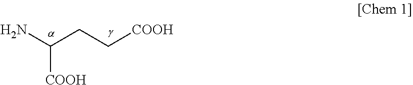

Chemical Structure of Glutamic Acid (GA)

One of the ways to increase the branching of a synthetic or natural polymer or of a polymer of natural origin consists in performing crosslinking reactions. The aim of the crosslinking of the polymer chains is to connect several polymer chains to one another which, when added to a polar phase, and more particularly to water, take the form of a three-dimensional network that is insoluble in water but is water-swellable, thus resulting in a chemical gel.

Crosslinked polymers may be prepared:
In one step by reacting the monomers and the crosslinking agent during the polymerization reaction, or
In at least two steps, the first of which consists in preparing the polymer, and the second consists in reacting the polymer with a crosslinking agent to obtain a crosslinked polymer.

Various reactions exist for the crosslinking of polyglutamic acid (PGA), which makes it possible to obtain polymers of natural origin with improved thickening properties in polar media, and in particular in aqueous media. Of the crosslinking agents known to be used in the PGA crosslinking reaction, polyepoxide derivatives are the most widely described since they make it possible to carry out crosslinking processes under environmentally friendly conditions (moderate temperatures, reaction in aqueous media and in the absence of harmful solvents).

However, the implementation of these processes requires diluting the PGA to high levels, which leads to the production of an aqueous gel comprising, per 100% of its mass, a content by mass of less than or equal to 10% of a polymer (P), which is difficult for formulators to implement.

Proceeding from this, a problem that arises is that of providing an easy-to-use liquid detergent composition for topical use comprising polymers of natural origin, the raw materials of which are renewable and which have thickening properties for polar media and particularly for aqueous media.

One solution of the present invention is a liquid detergent composition (F) for household or industrial use, comprising at least one detersive surfactant and, as thickening agent, a polymer (P) in the form of a pulverulent solid consisting of monomer units derived from partially or totally salified glutamic acid (GA) and of monomer units of at least one crosslinking agent (XLA) bearing at least two glycidyl functions.

For the purposes of the invention, the term “pulverulent solid” means a solid consisting of fine particles having little or no bonding to one another.

In the polymer (P) present in the liquid detergent composition (F) that is the subject of the present invention, the monomer units derived from partially or totally salified glutamic acid (GA) are linked together:
either in such a way that the amine function of a glutamic acid (GA) monomer unit is covalently linked to the carboxylic function present in the alpha (a) position of a second glutamic acid (GA) monomer unit; the resulting polymer is then referred to as a “α-polyglutamic acid” or PAGA (cf. chemical formula 2), which is partially or totally salified,

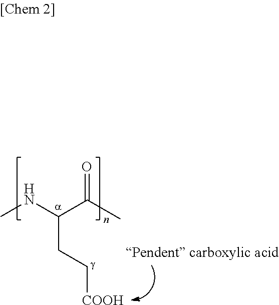

Chemical Structure of α-Polyglutamic Acid or PAGA
or in such a way that the amine function of a glutamic acid (GA) monomer unit is covalently linked to the carboxylic function of the side chain located in the gamma (γ) position of a second glutamic acid (GA) monomer unit; the resulting polymer is then called “γ-polyglutamic acid” or PGGA (cf. chemical formula 3) which is partially or totally salified.

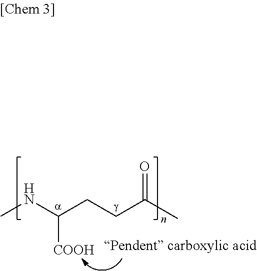

Chemical Structure of γ-Polyglutamic Acid or PGGA.

In general, PGA may be prepared chemically according to peptide synthesis methods known to those skilled in the art, notably passing through selective protection, activation, coupling and deprotection steps. The coupling generally consists of a nucleophilic attack of the amine function of a glutamic acid monomer unit on an activated carboxylic acid function of another glutamic acid monomer unit.

PGGA can also be obtained via processes comprising at least one microbial fermentation step involving the use of at least one bacterial strain.

For the purposes of the present invention, in the polymer (P) as defined previously the term “salified” indicates that the “pendent” carboxylic acid function present on each glutamic acid (GA) monomer unit of the polymer (in the gamma position in the case of PAGA or in the alpha position in the case of PGGA) is present in an anionic or carboxylate form. The counterion of this carboxylate function is a cation derived, for example, from alkali metal salts such as sodium, potassium or salts of nitrogenous bases such as amines, lysine or monoethanolamine (HO—CH₂— CH₂—NH₂).

For the purposes of the present invention, the term “crosslinking agent (XLA) bearing at least two glycidyl functions” denotes a crosslinking agent (XLA) as defined above, the molecular structure of which comprises at least two glycidyl units or functions of formula (I′):

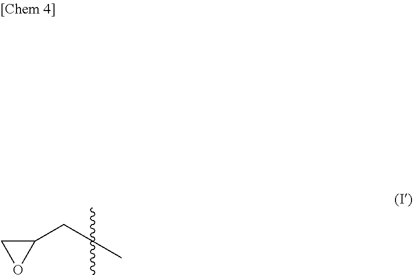 [SMILES: *CC1CO1]

The crosslinking of the polymer chains of the polymer (P) is performed according to a reaction between the terminal free amine function (—NH2) and/or one or more “pendent” or terminal carboxylic or carboxylate functions (—COOH or —COO⁻) present in the structure of said polymer (P), and at least one epoxy group present in the structure of the crosslinking agent (XLA) bearing at least two glycidyl functions.

For the purposes of the present invention, the term “detersive surfactants” denotes surfactants that give the aqueous liquid detergent composition (F) its ability to remove soiling present on the solid surfaces and to keep it in suspension, in order for it to then be removed during the rinsing step.

The crosslinking agent (XLA) may be chosen from the members of the group consisting of:
monoethylene glycol diglycidyl ether of formula (I):

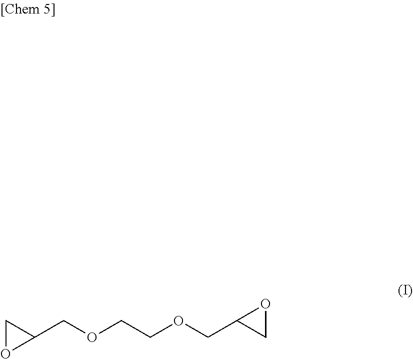 [SMILES: C(COCC1CO1)OCC1CO1]

the compound of formula (II):

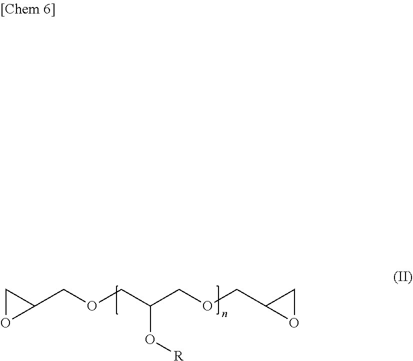

with R representing a hydrogen atom or the glycidyl radical

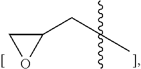 [SMILES: *CC1CO1]

and n representing an integer greater than or equal to one and less than or equal to 10;
1,3-propanediol diglycidyl ether of formula (III):

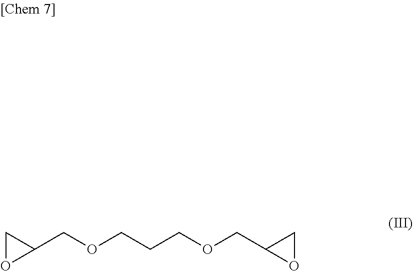 [SMILES: C(COCC1CO1)COCC1CO1]

1,2-propanediol diglycidyl ether of formula (IV):

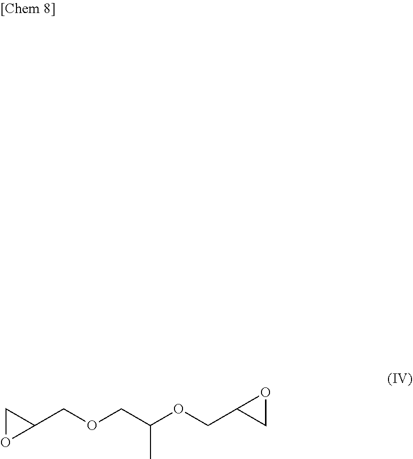

1,4-butanediol diglycidyl ether of formula (V):

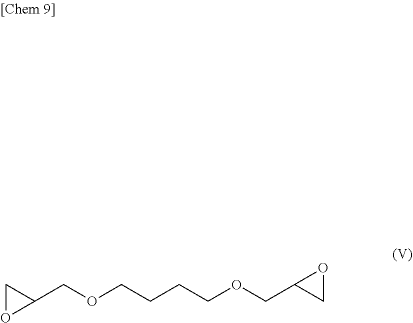 [SMILES: C(CCOCC1CO1)COCC1CO1]

1,2-butanediol diglycidyl ether of formula (VI):

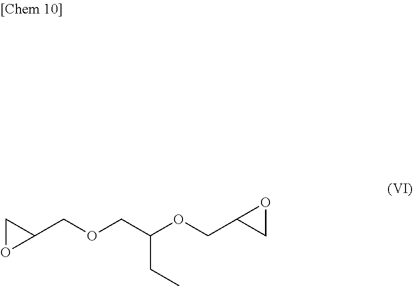

1,3-butanediol diglycidyl ether of formula (VII):

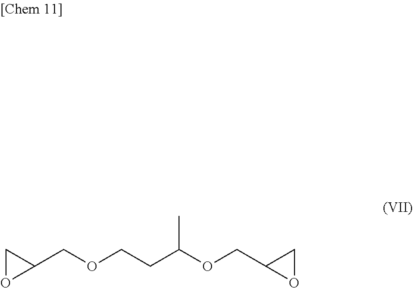

1,6-hexanediol diglycidyl ether of formula (Vill):

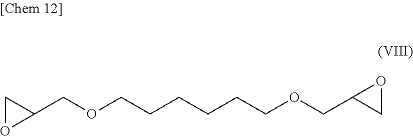 [SMILES: C(CCCOCC1CO1)CCOCC1CO1]

the compound of formula (IX):

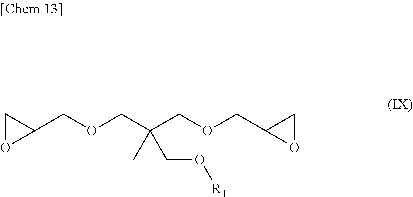

with R1 representing a hydrogen atom or the glycidyl radical

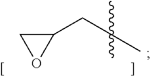 [SMILES: *CC1CO1]

the compound of formula (X):

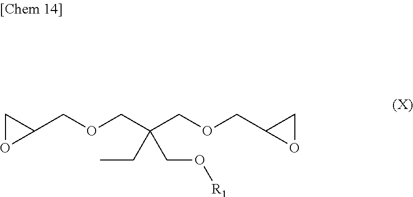

with R1 representing a hydrogen atom or the glycidyl radical

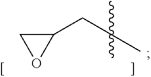 [SMILES: *CC1CO1]

the compound of formula (XI):

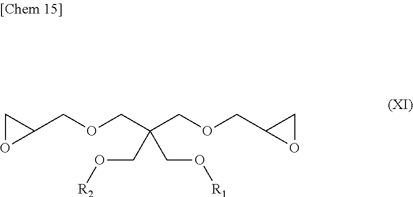

with R1 and R2 independently representing a hydrogen atom or the glycidyl radical [

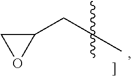 [SMILES: *CC1CO1]

the compound of formula (XII):

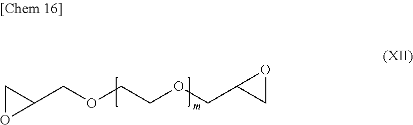

with m representing an integer greater than or equal to 2,
   the compound of formula (XIII):

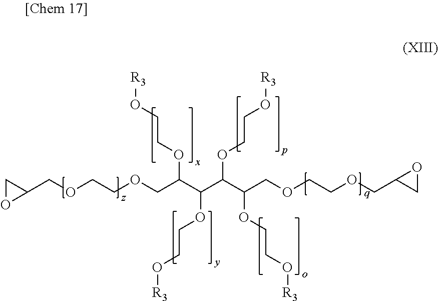

with R3 representing a hydrogen atom or the glycidyl radical

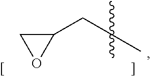 [SMILES: *CC1CO1]

and x, y, z, o, p and q, independently of each other, representing an integer greater than or equal to 2 and less than or equal to 10.

Depending on the case, the liquid detergent composition (F) can exhibit one or more of the following characteristics:
in the polymer (P), per 100 mol % of monomer units derived from partially or totally salified glutamic acid (GA), the crosslinking agent (XLA) represents from 0.5 mol % to 20 mol %, more particularly from 0.5 mol % to 15 mol %, and more particularly still from 0.5 mol % to 12 mol %.
the polymer (P) additionally comprises a compound of formula (XIV):

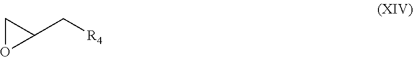

with R4 representing a linear or branched, saturated or unsaturated, hydrocarbon-based radical, optionally containing at least one hydroxyl function, being functionalized or non-functionalized and containing from 6 to 22 carbon atoms.

In formula (XIV), R4 represents a hydrocarbon-based radical chosen from the elements of the group consisting of the heptyl, octyl, nonyl, decyl, undecyl, undecenyl, dodecyl, tridecyl, tetradecyl, pentadecyl, hexadecyl, heptadecyl, octadecyl, hydroxyoctadecyl, oleyl, linoleyl, linolenyl, eicosyl and dodecosyl radicals.

According to one particular aspect, in formula (XIV), R4 represents a hydrocarbon-based radical chosen from the elements of the group consisting of the n-octyl, n-nonyl, n-decyl, n-undecyl, n-undecenyl, n-dodecyl, n-tetradecyl, n-hexadecyl, n-octadecyl, 12-hydroxyoctadecyl, n-eicosyl and n-dodecosyl radicals.

According to another particular aspect, in said polymer (P), per 100% of the mass of monomer units derived from partially or totally salified glutamic acid (GA), the compound of formula (XIV) represents from 1% to 50% by mass.

PGGA can exist in different conformational forms in solution in water. These forms depend on the inter- and intra-molecular hydrogen bonds and thus on the pH, the polymer concentration, the ionic strength of the solution, and also the temperature. The PGGA chains can thus take the form of an α-helix, a β-sheet, aggregates, or else be in a disordered and random state.

According to a particular aspect, the polymer (P) is in a helical conformation when it is present in a solution in a mass content of less than or equal to 0.1% and of which said aqueous solution has a pH value of less than or equal to 7.

According to a particular aspect, the polymer (P) is in sheet conformation when it is present in an aqueous solution in a mass content of less than or equal to 0.1% and of which said solution has a pH value above 7.
The liquid detergent composition (F) comprises, per 100% of its mass, between 0.1% and 10% by mass of said polymer (P), more particularly between 0.1% and 8% by mass, and more particularly still between 0.1% and 5% by mass.
In the liquid detergent composition (F), the detersive surfactant is chosen from anionic, cationic, amphoteric or nonionic detersive surfactants.

Among the anionic detersive surfactants capable of being used for the preparation of the aqueous liquid detergent composition (F) as defined above, mention may be made of alkali metal salts, alkaline-earth metal salts, ammonium salts, amine salts, amino alcohol salts of alkyl ether sulfates, of alkyl sulfates, of alkylamido ether sulfates, of alkylaryl polyether sulfates, of monoglyceride sulfates, of alpha-olefin sulfonates, of paraffin sulfonates, of alkyl phosphates, of alkyl ether phosphates, of alkyl sulfonates, of alkylamide sulfonates, of alkylaryl sulfonates, of alkyl carboxylates, of alkyl sulfosuccinates, of alkyl ether sulfosuccinates, of alkylamide sulfosuccinates, of alkyl sulfoacetates, of alkyl sarcosinates, of acyl isethionates, of N-acyl taurates, of acyl lactylates, of N-acyl amino acid derivatives, of N-acyl peptide derivatives, of N-acyl protein derivatives and of fatty acids.

Among the amphoteric detergent surfactants capable of being used for the preparation of the aqueous liquid detergent composition (F) as defined above, mention may be made of alkyl betaines, alkyl amido betaines, sultaines, alkyl amidoalkyl sulfobetaines, imidazoline derivatives, phosphobetaines, amphopolyacetates and amphopropionates.

Among the cationic detergent surfactants capable of being used for the preparation of the aqueous liquid detergent composition (F) as defined above, mention may particularly be made of quaternary ammonium derivatives.

Among the nonionic detergent surfactants capable of being used for the preparation of the aqueous liquid detergent composition (F) as defined above, mention may particularly be made of alkyl polyglycosides comprising a linear or branched, saturated or unsaturated aliphatic radical and comprising from 8 to 16 carbon atoms; castor oil derivatives, polysorbates, coconut amides and N-alkylamines.

The present invention also provides a process for preparing a polymer (P) as defined above, comprising:
a step (A) of preparing a polymer (P), comprising the following substeps:
a. a step of preparing a polar phase (PP) comprising partially or totally salified PGA, at least one polar solvent (PS) and at least one crosslinking agent (XLA) comprising at least two glycidyl functions,
b. a step of adjusting the pH of the aqueous solution obtained in step a) to a pH of between 3 and 11, and
c. a step of spray-drying the polar phase (PP) resulting from step b) so as to obtain the polymer (P) and
   a step B) of mixing at least one polymer (P) prepared during step A) with at least one detersive surfactant.

As the case may be, the process according to the invention may have one or more of the following features:

In step a):
The polyglutamic acid is gamma-polyglutamic acid (PGGA),
All the monomer units constituting the PGA are derived from sodium glutamate, potassium glutamate, ammonium glutamate, calcium glutamate, magnesium glutamate or a mixture of these forms,
The polar phase (PP) comprises, per 100% of its mass: from 5% to 80% by mass of the polyglutamic acid (PGA) of the polymer (P), from 0.025% to 78% by mass of the crosslinking agent (XLA), from 12% to 94.975% by mass of at least one polar solvent,
The polar solvent is chosen from the elements of the group consisting of water, methanol, ethanol, 1-propanol, 2-propanol, isobutanol, tert-butanol, 2-methyl-2-propanol, 1-butanol, 2-butanol, acetone, dimethyl ketone, diethyl ketone, tetrahydropyran, tetrahydrofuran, 2-methyltetrahydrofuran, 1,3-dioxane and 1,4-dioxane.
The polar phase (PP) also comprises at least one compound of formula (XIV):

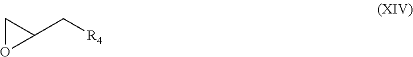

with R4 representing a linear or branched, saturated or unsaturated hydrocarbon-based radical optionally including at least one hydroxyl function and including from 6 to 22 carbon atoms,
R4 representing a hydrocarbon-based radical chosen from the elements of the group consisting of the heptyl, octyl, nonyl, decyl, undecyl, undecenyl, dodecyl, tridecyl, tetradecyl, pentadecyl, hexadecyl, heptadecyl, octadecyl, hydroxyoctadecyl, oleyl, linoleyl, linolenyl, eicosyl and dodecosyl radicals.

According to one particular aspect, in formula (XIV), R4 represents a hydrocarbon-based radical chosen from the elements of the group consisting of the n-octyl, n-nonyl, n-decyl, n-undecyl, n-undecenyl, n-dodecyl, n-tetradecyl, n-hexadecyl, n-octadecyl, 12-hydroxyoctadecyl, n-eicosyl and n-dodecosyl radicals.
The content of compound of formula (XIV) in the polar phase (PP) is, per 100% by mass of said polar phase (PP), between 0.05% and 35% by mass, it being understood that the sum of the proportions by mass of the polyglutamic acid (PGA), of the crosslinking agent (XLA), of the polar solvent (PS) and of the compound of formula (XIV) is equal to 100%.

In step b):
The pH is between 4 and 10, preferably between 5 and 7.

In step c):
The drying is performed with an atomizer using an air stream and a nozzle,
The inlet temperature of the air flow is between 80° C. and 180° C., preferably between 100° C. and 170° C.

According to one particular aspect, the polar phase (PP) comprises, per 100% of its mass: from 5% to 70% by mass of the polyglutamic acid (PGA) of the polymer (P), from 0.025% to 7% by mass of the crosslinking agent (XLA), from 23% to 94.975% by mass of at least one polar solvent (PS).

According to an even more particular aspect, the polar phase (PP) comprises, per 100% of its mass: from 5% to 60% by mass of the polyglutamic acid (PGA) of the polymer (P), from 0.025% to 6% by mass of the crosslinking agent (XLA), from 34% to 94.975% by mass of at least one polar solvent (PS).

According to another particular aspect, the polar solvent (PS) is chosen from the following list: water, ethanol, acetone, dimethyl ketone.

According to another even more particular aspect, the polar solvent (PS) is water.

According to another particular aspect, R4 representing a hydrocarbon-based radical is chosen from the elements of the group consisting of n-octyl, n-nonyl, n-decyl, n-undecyl, n-undecenyl, n-dodecyl, n-tetradecyl, n-hexadecyl, n-octadecyl, 12-hydroxyoctadecyl, n-eicosyl and n-dodecosyl radicals.

According to another particular aspect, the content of compound of formula (XIV) in the polar phase (PP) is, per 100% by mass of said polar phase (PP), between 0.05% and 20% by mass, and more particularly still between 0.05% and 15% by mass, it being understood that the sum of the proportions by mass of the polyglutamic acid (PGA), of the crosslinking agent (XLA), of the polar solvent (PS) and of the compound of formula (XIV) is equal to 100%.

Another subject of the invention is the use of said polymer (P) as defined above as a thickening agent and/or emulsifier and/or stabilizer for an aqueous liquid detergent composition (F) for domestic or industrial use.

According to a particular aspect, said use consists in thickening polar phases, for instance aqueous, alcoholic or aqueous-alcoholic phases or polar phases comprising polyols such as glycerol.

According to another particular aspect, said use consists in stabilizing an emulsion of oil-in-water type, or of water-in-oil type, giving said emulsion a homogeneous appearance during storage under various conditions, and more particularly at 25° C. for a time at least equal to one month, and more particularly at 4° C. for a time at least equal to one month, and more particularly at 45° C. for a time at least equal to one month.

According to another particular aspect, said use consists in stabilizing solid particles in aqueous liquid detergent compositions for domestic or industrial use.

These solid particles to be suspended may have various regular or irregular geometries, and may be in the form of pearls, beads, rods, flakes, leaflets or polyhedra. These solid particles are characterized by an apparent mean diameter of between 1 μm and 5 mm, more particularly between 10 μm and 1 mm.

The solid particles that may be suspended and stabilized with the polymer (P) as defined previously in liquid detergent compositions for domestic or industrial use include micas, iron oxide, titanium oxide, zinc oxide, aluminum oxide, talc, silica, kaolin, clays, boron nitride, calcium carbonate, magnesium carbonate, magnesium hydrogencarbonate, inorganic colored pigments, polyamides, such as nylon-6, polyethylenes, polypropylenes, polystyrenes, polyesters, acrylic or methacrylic polymers, such as polymethyl methacrylates, polytetrafluoroethylene, crystalline or microcrystalline waxes, porous spheres, selenium sulfide, zinc pyrithione, starches, alginates, plant fibers, loofah particles and sponge particles.

Said liquid detergent composition (F) that is the subject of the present invention is notably in the form of an aqueous solution, an emulsion or a microemulsion with an aqueous continuous phase, an emulsion or a microemulsion with an oily continuous phase, an aqueous gel, a foam, or else in the form of an aerosol. It may be applied directly by soaking, by spraying or by vaporizing onto the surface to be cleaned or else by means of any type of support intended to be placed in contact with the solid surface to be cleaned (paper, wipe, textile).

In general, said liquid detergent composition (F) that is the subject of the present invention also comprises ingredients usually used in the field of cleaning solid surfaces or textile fibers, such as nonionic, cationic or amphoteric surfactants, cationic or nonionic polymers, thickeners, enzymes, bleaching agents, anticorrosion agents, solvents, acidic agents, alkaline agents, antilimescale agents, preservatives, fragrances, colorants, repellents, oxidizing agents, detergency adjuvants, antisoiling agents or antiredeposition agents.

Among the mineral acids that are particularly chosen as acidic agents in said liquid detergent composition (F), mention may be made of hydrochloric acid, nitric acid, phosphoric acid, sulfuric acid, hypophosphorous acid, phosphorous acid, hypochlorous acid, perchloric acid, carbonic acid, boric acid, manganic acid, permanganic acid, chromic acid, periodic acid, iodic acid, hypoiodous acid, hydrobromic acid, hydroiodic acid and hydrofluoric acid.

Among the organic acids that are particularly chosen as acidic agents in said liquid detergent composition (F), mention may be made of formic acid, acetic acid, propionic acid, benzoic acid, salicylic acid, oxalic acid, malonic acid, succinic acid, glutaric acid, adipic acid, glycolic acid, lactic acid, malic acid, maleic acid, tartaric acid, citric acid, sorbic acid, sulfamic acid, dihydroacetic acid, dimethylsulfamic acid, fumaric acid, glutamic acid, isopropylsulfamic acid, valeric acid, benzenesulfonic acid, xylenesulfonic acid, 2-ethylhexanoic acid, capric acid, caproic acid, cresylic acid, dodecylbenzenesulfonic acid, peracetic acid, monochloroacetic acid and gluconic acid.

Among the alkaline agents associated with the polymer (P) as defined above in said liquid detergent composition (F), mention may be made of the elements of the group consisting of alkali metal or alkaline-earth metal hydroxides, for instance sodium hydroxide, potassium hydroxide, barium hydroxide and calcium hydroxide.

Among the antilimescale agents associated with the polymer (P) as defined above in said liquid detergent composition (F), mention may be made of the elements of the group consisting of sequestrants, for instance sodium tripolyphosphate (TPP), ethylenediaminetetraacetate (EDTA), tetraacetylethylenediamine (TAED), methylglycine diacetate (MGDA), sodium nitrilotriacetate (Na3NTA), sodium or potassium gluconate, sodium or potassium erythorbate, sodium or potassium polycarboxylate, and sodium citrate, of ion-exchange agents, for instance sodium zeolites or aluminosilicates, or lamellar sodium silicates, and precipitating agents, for instance calcium carbonate and sodium metasilicate.

The sequestrants, and more particularly the sequestrants described above, have the effect of complexing calcium and magnesium ions to form water-soluble complexes which are then removed during rinsing. The ion-exchange agents, and more particularly the ion-exchange agents described above, have the effect of exchanging their sodium ions with calcium and magnesium ions. The precipitating agents, and more particularly the sequestrants described above, have the effect of removing the ions responsible for the hardness of water by forming insoluble calcium compounds, which are subsequently removed with the soiling on the cleaned surfaces.

According to a more particular aspect, in said liquid detergent composition (F), the antilimescale agent is chosen from the elements of the group consisting of sodium metasilicate, sodium tripolyphosphate (TPP), ethylenediaminetetraacetate (EDTA), tetraacetylethylenediamine (TAED), methylglycine diacetate (MGDA), sodium nitrilotriacetate (Na3NTA), sodium gluconate, sodium citrate and calcium carbonate.

Among the nonionic surfactants that may be associated with said polymer (P) as defined above in said aqueous liquid detergent composition (F), mention may be made of:
block copolymers of ethylene oxide and of propylene oxide, and most particularly the block copolymers of ethylene oxide and of propylene oxide sold under the brand name Pluronic™ by the company BASF, for instance Pluronic™ PE 6100 and Pluronic™ PE 6200,
defoaming nonionic surfactants of formula (A₁):

R₁—X—[(CH₂—CH(CH₃)—O)_{u′}—(CH₂—CH₂—O)_{v′}—Y]_{w′} (A₁)

in which R₁ represents a saturated or unsaturated, linear or branched hydrocarbon-based aliphatic radical comprising from 6 to 18 carbon atoms, X represents a nitrogen atom or an oxygen atom, u′ and v′, which may be identical or different, each represent an integer between 1 and 50, w′ is either equal to 1 if X represents an oxygen atom, or equal to 1 or to 2 if X represents a nitrogen atom, and Y represents a blocking functional group chosen from the elements of the group consisting of linear alkyl radicals comprising from 4 to 8 carbon atoms, for instance the butyl radical, the benzyl radical or a butylene oxide group.

Among the defoaming nonionic surfactants of formula (A₁), mention may be made of the products sold under the brand name Tergitol™ by the company Dow Chemical, for instance Tergitol™ L61E and Tergitol™ L64E,
sparingly foaming nonionic surfactants of formula (A₂):

R₈—O—(S′)_{q′}—H (A₂)

in which S′ represents a reducing sugar residue chosen from the elements of the group consisting of glucose, xylose and arabinose, R₈ represents a saturated, linear or branched hydrocarbon-based radical comprising from 6 to 10 carbon atoms and q′ represents a decimal number greater than or equal to 1.05 and less than or equal to 5.

As examples of sparingly foaming nonionic surfactants of formula (A₂) optionally present in said liquid detergent composition (F), mention may be made of hexyl polyglucosides, 2-ethylhexyl polyglucosides, n-heptyl polyglucosides and n-octyl polyglucosides.

Among the foaming and/or detergent amphoteric surfactants that may be associated with the polymer (P) as defined previously in said liquid detergent composition (F), there are alkylbetaines, alkylamidobetaines, sultaines, alkylamidoalkylsulfobetaines, imidazoline derivatives, phosphobetaines, amphopolyacetates and amphopropionates, β-alanine, and sodium N-(2-carboxyethyl)-N-(2-ethylhexyl) sold under the brand name Tomamine® 30 Amphoteric 400 Surfactant.

Among the nonionic surfactants that may be associated with said polymer (P) as defined previously in said aqueous liquid detergent composition (F), mention may be made of alkoxylated monoglycerides, alkoxylated diglycerides, alkoxylated terpenic hydrocarbons such as ethoxylated and/or propoxylated α- or β-pinenes, containing from 1 to 30 oxyethylene and/or oxypropylene units, products resulting from the condensation of ethylene oxide or of propylene oxide with ethylenediamine, such as the Tetronic™ products sold by BASF, ethoxylated and/or propoxylated C8-C18 fatty acids containing from 5 to 25 mol of ethylene oxide and/or propylene oxide, ethoxylated fatty amides containing from 5 to 30 mol of ethylene oxide, ethoxylated amines containing from 5 to 30 mol of ethylene oxide, and alkoxylated amidoamines containing from 1 to 50, preferably from 1 to 25 and most particularly from 2 to 20 mol of ethylene oxide and/or of propylene oxide.

Among the thickeners and/or gelling agents that may be associated with said polymer (P) as defined previously in said aqueous liquid detergent composition (F), mention may be made of polysaccharides consisting only of monosaccharides, such as glucans or glucose homopolymers, glucomannoglucans, xyloglycans, galactomannans of which the degree of substitution (DS) of the D-galactose units on the main D-mannose chain is between 0 and 1, and more particularly between 1 and 0.25, such as galactomannans originating from cassia gum (DS=1/5), locust bean gum (DS=1/4), tara gum (DS=1/3), guar gum (DS=1/2) or fenugreek gum (DS=1).

Among the thickeners and/or gelling agents that may be associated with said polymer (P) as defined previously in said aqueous liquid detergent composition (F), mention may be made of polysaccharides consisting of monosaccharide derivatives, such as sulfated galactans and more particularly carrageenans and agar, uronans and more particularly algins, alginates and pectins, heteropolymers of monosaccharides and of uronic acids, and more particularly xanthan gum, gellan gum, acacia gum exudates and karaya gum exudates, and glucosaminoglycans.

Among the thickeners and/or gelling agents that may be associated with said polymer (P) as defined previously in said liquid detergent composition (F), mention may be made of cellulose, cellulose derivatives such as methyl cellulose, ethyl cellulose, hydroxypropyl cellulose, silicates, starch, hydrophilic starch derivatives, and polyurethanes.

Among the thickeners and/or gelling agents that may be associated with said polymer (P) as defined previously in said liquid detergent composition (F), mention may be made of inorganic thickeners, for instance clays, hectorite, saponite, sauconite, vermiculite or colloidal silica.

The thickeners present in the detergent composition (F) that is the subject of the present invention are used in amounts of between 0.1% and 10% by mass.

Among the abrasive agents that may be associated with said polymer (P) as defined previously in said liquid detergent composition (F), mention may be made of materials of natural origin, for instance wood or kernel chips, inorganic abrasive materials such as oxides, quartzes, diatomaceous earths, colloidal silica dioxides, organic abrasive materials such as polyolefins, for instance polyethylenes and polypropylenes, polystyrenes, acetonitrile-butadiene-styrene resins, melamines, phenolic resins, epoxy resins or polyurethane resins.

The abrasive agents present in the detergent composition (F) that is the subject of the present invention are used in amounts of between 5.0% and 30% by mass.

Among the solvents that may be associated with said polymer (P) as defined previously in said liquid detergent composition (F), mention may be made of isopropyl alcohol, benzyl alcohol, 1,3-propanediol, chlorinated solvents, acetone, methyl ethyl ether, methyl isobutyl ether, butyl acetate, ethyl acetate, isopropyl acetate, isobutyl acetate, aromatic solvents, isoparaffins, isododecane, ethyl lactate, butyl lactate, terpenic solvents, rapeseed methyl esters, sunflower methyl esters, propylene glycol n-methyl ether, dipropylene glycol n-methyl ether, tripropylene glycol n-methyl ether, propylene glycol n-butyl ether, dipropylene glycol n-butyl ether, tripropylene glycol n-butyl ether, propylene glycol n-propyl ether, dipropylene glycol n-propyl ether, propylene glycol monomethyl ether acetate, propylene glycol diacetate, propylene glycol phenyl ether, ethylene glycol phenyl ether or dipropylene glycol dimethyl ether.

As examples of solvents present in the detergent composition (F) that is the subject of the present invention, mention may be made more particularly of the elements from the group consisting of propylene glycol n-methyl ether, dipropylene glycol n-methyl ether, tripropylene glycol n-methyl ether, propylene glycol n-butyl ether, dipropylene glycol n-butyl ether, tripropylene glycol n-butyl ether, propylene glycol n-propyl ether, dipropylene glycol n-propyl ether, propylene glycol phenyl ether, ethylene glycol phenyl ether, dipropylene glycol dimethyl ether, rapeseed methyl esters and sunflower methyl esters.

Among the enzymes that may be associated with said polymer (P) as defined previously in said liquid detergent composition (F), mention may be made of proteases, amylases, lipases, cellulases and peroxidases.

The enzymes present in the detergent composition (F) that is the subject of the present invention are used in amounts of between 0.005% and 0.5% by mass.

Lastly, the present invention also provides:
The use of said aqueous liquid detergent composition (F) according to the invention, for cleaning solid surfaces.
A process for cleaning a solid surface, characterized in that it comprises at least one first step a″1) of applying said aqueous liquid detergent composition (F) according to the invention to the solid surface, and a second step b″1) of rinsing said solid surface.

The expression “for cleaning solid surfaces” denotes any action intended for removing soiling present on surfaces consisting of various materials.

The surfaces to be cleaned may be solid surfaces or textile surfaces. The term “solid surfaces” denotes, for example, floors, walls, window panes, tiles, household electrical appliances, kitchenware, countertops, tapware, sinks, tanks for storing chemical, food or agricultural products, vehicles (motor vehicles, motorbikes, trucks, etc.). The materials constituting these solid surfaces are, for example, glass (soda-lime, fluorocalcium, borosilicate, crystal), porcelain, earthenware, ceramic, polycarbonate or polypropylene plastics, stainless steel, silver, copper, aluminum, wood, synthetic resins, glass-ceramic or linoleum, and may be coated with paints or varnishes. As examples of soiling that is present on these solid surfaces and that is to be removed by cleaning, mention may for example be made of food residues, grease, light and heavy hydrocarbons, burnt residues, dust, sludge, finger marks, soap residues and microorganisms.

According to another aspect, a subject of the invention is a process for cleaning a solid surface, characterized in that it comprises at least one first step a″) of applying said aqueous liquid detergent composition (F) as defined above, followed by at least one step b″) of rinsing said solid surface.

In step a″) of the process as defined above, said liquid detergent composition (F) is applied to the surface comprising the soiling to be cleaned by any means, for instance by total immersion, by spraying or by application by means of a support consisting of synthetic or natural, woven or nonwoven textile fibers, or paper, impregnated beforehand with said composition.

In step b″) of the process as defined above, the rinsing of the solid surface onto which the detergent composition (F) for domestic or industrial use has been applied during step a″) is performed by total immersion or by spraying with water. Step b″) of the cleaning process that is the subject of the invention may be performed at room temperature or at a temperature of between 30° C. and 80° C., more particularly at a temperature of between 30° C. and 65° C.

### EXAMPLES

The examples that follow illustrate the invention without, however, limiting it.

### Example 1: Preparation of a Sodium PGGA According to the Invention Crosslinked with Polyethylene Glycol Diglycidyl Ether and Atomized

The synthetic process comprises the following 4 steps:

Step 1): Preparation of an Aqueous Sodium PGGA Gel:

200 grams of demineralized water are stirred with a Rayneri™ brand mechanical stirrer equipped with a deflocculating-type rotor, and 20 grams of PGGA, sold by the company Lubon under the name Cosmetic Grade PGGA, are then slowly added into the vortex.

Step 2): pH Adjustment:

The pH of the mixture from step 1) is adjusted to a value of between 5.5 and 6.0 using aqueous 5M HCl solution (temperature=20° C.).

Step 3): Addition of the Crosslinking Agent:

To the mixture from step 2) are added 1.2 grams of polyethylene glycol diglycidyl ether (PEGDGE) with an average molecular weight of the order of 500 g/mol.

Step 4): Atomization:

The aqueous solution obtained in step 3) is concentrated by passage through an atomizer whose operating parameters are as follows:
Rate of introduction of the solution=4 ml/min,
Pressure of spraying nozzle=1.5 bar,
Circulating air temperature=150° C.,

Composition (E1) is finally isolated in the form of a pulverulent powder.

### Example 2: Preparation of a Sodium PGGA According to the Invention Crosslinked with 1,4-Butanediol Diglycidyl Ether and Atomized

The synthesis process of example 1 is reproduced, replacing the 1.2 grams of polyethylene glycol diglycidyl ether (PEGDGE) with 0.48 gram of 1,4-butanediol diglycidyl ether sold under the name Erisys™ GE 21 by Emerald.

The composition (E2) obtained is finally isolated in the form of a pulverulent powder.

### Evaluation of the Crosslinked and Atomized Sodium PGGAs Obtained in the Two Preceding Examples:

The evaluation of compositions (E1) and (E2) (crosslinked and atomized sodium PGGAs), obtained in the two preceding examples was performed as follows:
In a 400 ml tall-form beaker, 4 grams of the polymer compositions to be tested in the form of a pulverulent powder are dispersed in 196 grams of water with stirring using a Rayneri™ brand mechanical stirrer equipped with a deflocculator-type rotor, until a homogeneous gel is obtained.
The dynamic viscosity is measured using a Brookfield RVT type viscometer, speed 5, choosing the appropriate spindle.
Addition of 0.1% of NaCl to the gel obtained previously, stirring with a Rayneri™ brand mechanical stirrer equipped with a deflocculating-type rotor, until the mixture is homogeneous,
Measurement of the dynamic viscosity using the same viscometer as previously, again choosing the appropriate spindle.

A control was produced from non-crosslinked PGGA sold by Lubon under the name “cosmetic grade PGGA”.

The measured dynamic viscosity values are collated in the table below:

TABLE 1

| | | | Viscosity in |
|---|---|---|---|
| | | Viscosity in | mPa · s |
| | | mPa · s | of the |
| | Nature of | of the | gel containing |
| | crosslinking | gel containing | 2% polymer + |
| Composition | agent | 2% polymer | 0.1% NaCl |
| Control^{a)} | No | 176 (spindle 2) | 128 (spindle 2) |
| Composition | PEGDGE | 30 400 (spindle 5) | 9320 (spindle 3) |
| (E1) | | | |
| Composition | Erisys ™ GE 21 | 41 520 (spindle 5) | / |
| (E2) | | | |

^{a)}Non-crosslinked PGGA sold by Lubon under the name “cosmetic grade PGGA”.

Table 1: Dynamic viscosities of aqueous gels obtained with compositions (E1) and (E2).

The control sodium PGGA gels (non-crosslinked and non-atomized) have viscosities of between 100 and 200 mPa·s in the presence or absence of NaCl.

In the absence of NaCl, the crosslinked and atomized sodium PGGA gels have viscosities respectively equal to 30 400 mPa·s in the case where the crosslinking agent is PEGDGE and 41 520 mPa·s with Erisys™ GE 21 as crosslinking agent.

In the presence of NaCl, the viscosity of the sodium PGGA gel crosslinked with PEGDGE and atomized is equal to 9320 mPa·s.

Compositions (E1) and (E2) according to the invention thus make it possible to thicken aqueous phases.

### 3—Illustrative Detergent Formulations

In the formulations below, the percentages are expressed as mass percentages per 100% of the mass of the formulation.

### 3.1—Cleaning Composition for Ovens and Cooking Grills

| Ingredients | Mass content |
|---|---|
| SIMULSOL ™OX1309L⁽¹⁾ | 2% |
| SIMULSOL ™SL7G⁽²⁾ | 2% |
| Composition (E₁) | 6% |
| Sodium hydroxide: | 25% |
| Water: | gs 100% |

⁽¹⁾Simulsol ™ OX1309L: detersive surfactant composition sold by SEPPIC, comprising polyethoxylated alcohols resulting from the reaction of 1 molar equivalent of an alcohol sold under the brand name Exxal ™13 with 9 molar equivalents of ethylene oxide.
⁽²⁾Simulsol ™SL7G: solution of n-heptyl polyglucosides, hydrotropic and solubilizing agent sold by SEPPIC.

### Preparation

a) A pre-gel is prepared at 20° C. by adding Simulsol™ OX1309L and then Simulsol™ SL7G to water. Composition (E1) according to the invention is then introduced into the aqueous solution and mixed until a gel of stable viscosity is obtained.
b) Sodium hydroxide is then gradually introduced with mechanical stirring at a temperature of 20° C. until a homogeneous gel is obtained. The gel obtained on conclusion of step b) is of homogeneous and clear appearance, with a viscosity of 10 000 mPa·s (Brookfield LVT at a speed of 6 rpm). After a period of storage of 6 months at 25° C., the gel obtained on conclusion of step b) of this procedure has a homogeneous and clear appearance, with a viscosity of 12 000 mPa·s (Brookfield LVT at a speed of 6 rpm).

### Cleaning Process

The composition prepared above is sprayed at room temperature onto the walls of an oven soiled with food grease and onto cooking grills also soiled with food grease. After 10 minutes, the walls of the oven and the cooking grills are rinsed with hot water at 60° C. The walls of the oven and the surfaces of the cooking grills thus cleaned no longer have any soiling.

### 3.2—Cleaner for Aluminum Surfaces

| Ingredients | Mass content |
|---|---|
| SIMULSOL ™ OX1309L | 3% |
| SIMULSOL ™ SL7G | 3% |
| Composition (E2) | 5% |
| 75% Phosphoric acid | 40% |
| Hordaphos⁽³⁾ MDGB 1% | 5% |
| Dipropylene glycol methyl ether | 5% |
| Water: | qs 100% |

⁽³⁾Hordaphos ™ MDGB is a composition based on phosphoric esters, used as an anticorrosion agent.

### Preparation

Each ingredient is successively introduced into a mixing tank with moderate mechanical stirring, at room temperature, until a homogeneous, clear composition is obtained. Stirring is maintained for 30 minutes at 20° C. The composition obtained has a measured pH value of less than 1.0 and is clear and homogeneous after storage for a period of one month at 40° C.

### Cleaning Process

The composition prepared in the preceding paragraph is diluted to 3% in water and the solution thus obtained is sprayed onto the aluminum wall to be cleaned. This wall is then rinsed with hot water at 60° C.

1. A liquid detergent composition (F) for household or industrial use, comprising at least one detersive surfactant and, as thickening agent, a polymer (P) in the form of a pulverulent solid consisting of monomer units derived from partially or totally salified glutamic acid (GA) and of monomer units of at least one crosslinking agent (XLA) bearing at least two glycidyl functions.

2. The liquid detergent composition (F) as claimed in claim 1, wherein, in the polymer (P), the crosslinking agent (XLA) is chosen from the members of the group consisting of:
ethylene glycol diglycidyl ether of formula (I) 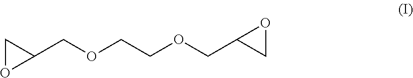 [SMILES: C(COCC1CO1)OCC1CO1]
the compound of formula (II) 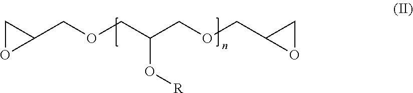
where R represents a hydrogen atom or the glycidyl radical 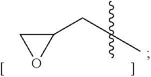 [SMILES: *CC1CO1]
and n represents an integer greater than or equal to 1 and less than or equal to 10;
propane-1,3-diol diglycidyl ether of formula (III) 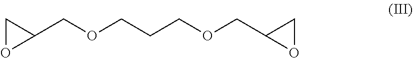 [SMILES: C(COCC1CO1)COCC1CO1]
propane-1,2-diol diglycidyl ether of formula (IV) 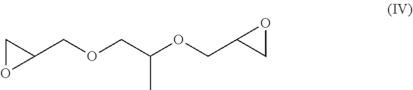
1,4-butanediol diglycidyl ether of formula (V) 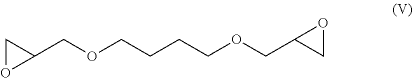 [SMILES: C(CCOCC1CO1)COCC1CO1]
butane-1,2-diol diglycidyl ether of formula (VI) 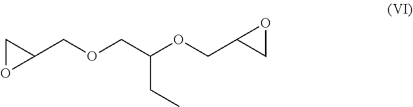
1,3-butanediol diglycidyl ether of formula (VII) 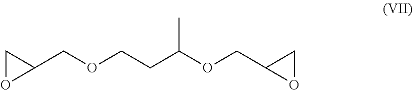
1,6-hexanediol diglycidyl ether of formula (VIII) 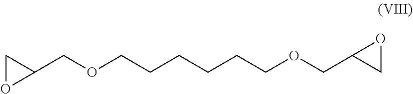 [SMILES: C(CCCOCC1CO1)CCOCC1CO1]
the compound of formula (IX) 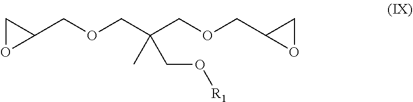
with R1 representing a hydrogen atom or the glycidyl radical 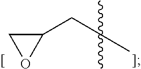 [SMILES: *CC1CO1]
the compound of formula (X) 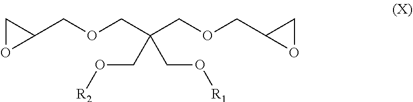
with R1 and R2 independently representing a hydrogen atom or the glycidyl radical 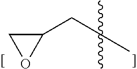 [SMILES: *CC1CO1]
the compound of formula (XI) 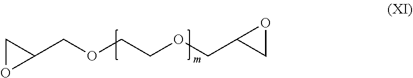
where m represents an integer greater than or equal to 2
the compound of formula (XII) 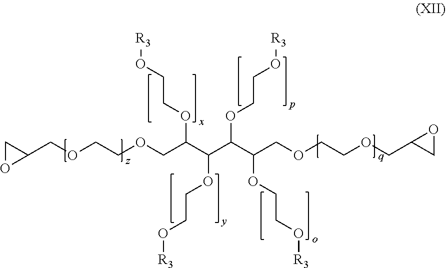
with R3 representing a hydrogen atom or the glycidyl radical 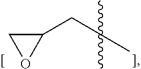 [SMILES: *CC1CO1]
and x, y, z, o, p and q, independently of one another, representing an integer greater than or equal to 2 and less than or equal to 10.

3. The liquid detergent composition (F) as defined in claim 1, wherein, in the polymer (P), per 100 mol % of monomer units derived from partially or totally salified glutamic acid (GA), the crosslinking agent (XLA) represents from 0.5 mol % to 20 mol %.

4. The liquid detergent composition (F) as claimed in claim 1, wherein said polymer (P) additionally comprises a compound of formula (XIV): 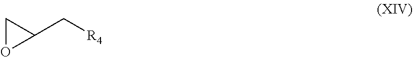
with R4 representing a linear or branched, saturated or unsaturated hydrocarbon-based radical containing from 6 to 22 carbon atoms.

5. The liquid detergent composition (F) as claimed in claim 4, wherein, in formula (XIV), R4 represents a hydrocarbon-based radical chosen from the elements of the group consisting of the octyl, nonyl, decyl, undecyl, dodecyl, tridecyl, tetradecyl, pentadecyl, hexadecyl, heptadecyl, octadecyl, oleyl, linoleyl, linolenyl, eicosyl and dodecosyl radicals.

6. The liquid detergent composition (F) as claimed in claim 4, wherein, in the polymer (P), per 100% of the mass of monomer units derived from partially or totally salified glutamic acid (GA), the compound of formula (XIV) represents from 1% to 50% by mass.

7. The liquid detergent composition (F) as claimed in claim 1, wherein it comprises, per 100% of its mass, between 0.1% and 10% by mass of said polymer (P).

8. The liquid detergent composition (F) as claimed in claim 1, wherein the detersive surfactant is chosen from anionic, cationic, amphoteric or nonionic detersive surfactants.

9. A process for preparing a liquid detergent composition (F) as defined in claim 1, comprising:
a step (A) of preparing a polymer (P), comprising the following substeps:
a) a step of preparing a polar phase (PP) comprising partially or totally salified polyglutamic acid, at least one polar solvent (PS) and at least one crosslinking agent (XLA) comprising at least two glycidyl functions,
b) a step of adjusting the pH of the aqueous solution obtained in step a) to a pH of between 3 and 11,
c) a step of drying by spraying the polar phase (PP) resulting from step b) so as to obtain the polymer (P),
a step B) of mixing at least one polymer (P) prepared during step A) with at least one detersive surfactant.

10. The process as claimed in claim 9, wherein, in step a), the polyglutamic acid is gamma-polyglutamic acid (PGGA).

11. The process as claimed in claim 10, wherein, in step a), all of the monomer units constituting the polyglutamic acid (PGA) are derived from sodium glutamate, potassium glutamate, ammonium glutamate, calcium glutamate, magnesium glutamate or a mixture of these forms.

12. The process as claimed in claim 9, wherein, in step a), the polar phase (PP) comprises, per 100% of its mass:
from 5% to 80% by mass of the polymer (P),
from 0.025% to 78% by mass of at least one crosslinking agent (XLA),
from 12% to 94.975% by mass of at least one polar solvent (PS).

13. The process as claimed in claim 9, wherein, in step a), the polar solvent (PS) is chosen from the elements of the group consisting of water, methanol, ethanol, 1-propanol, 2-propanol, isobutanol, tert-butanol, 2-methyl-2-propanol, 1-butanol, 2-butanol, acetone, dimethyl ketone, diethyl ketone, tetrahydropyran, tetrahydrofuran, 2-methyltetrahydrofuran, 1,3-dioxane, 1,4-dioxane.

14. The process as claimed in claim 9, wherein, in step a), the polar phase also comprises at least one compound of formula (XIV): 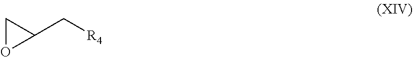
with R4 representing a linear or branched, saturated or unsaturated hydrocarbon-based radical, optionally containing at least one hydroxyl function and containing from 6 to 22 carbon atoms.

15. The process as claimed in claim 14, wherein R4 represents a hydrocarbon-based radical chosen from the elements of the group consisting of the octyl, nonyl, decyl, undecyl, dodecyl, tridecyl, tetradecyl, pentadecyl, hexadecyl, heptadecyl, octadecyl, oleyl, linoleyl, linolenyl, eicosyl and dodecosyl radicals.

16. The process as claimed in claim 14, wherein the content of compound of formula (XIV) in the polar phase (PP) is, per 100% by mass of said polar phase (PP), between 0.05% and 35% by mass, it being understood that the sum of the proportions by mass of the polyglutamic acid (PGA), of the crosslinking agent (XLA), of the polar solvent (PS) and of the compound of formula (XIV) is equal to 100%.

17. The process as claimed in claim 9, wherein step c) is performed with an atomizer using an air stream and a nozzle.

18. The process as claimed in claim 17, wherein the inlet temperature of the air stream is between 80 and 180° C. and preferably between 100 and 170° C.

19. The use of said aqueous liquid detergent composition (F) as defined in claim 1, for cleaning solid surfaces.

20. A process for cleaning a solid surface, wherein it comprises at least one first step a″) of applying said aqueous liquid detergent composition (F) as defined in claim 1 to the solid surface, and a second step b″) of rinsing said solid surface.
